(19) United States
(12) Patent Application Publication
(10) Pub. No.: US 2008/0082255 A1
(43) Pub. Date: Apr. 3, 2008

(54) Data update system, navigation apparatus, and data update method

(75) Inventors: Seiji Takahata, Okazaki-shi (JP); Tomofumi Shibata, Okazaki-shi (JP)

Correspondence Address: BACON & THOMAS, PLLC, 625 SLATERS LANE, FOURTH FLOOR, ALEXANDRIA, VA, 22314, US

(73) Assignee: AISIN AW CO., LTD., Anjo-shi (JP)

(21) Appl. No.: 11/905,215

(22) Filed: Sep. 28, 2007

(30) Foreign Application Priority Data
Sep. 29, 2006 (JP) 2006-269311

(51) Int. Cl. G01C 21/00; G06F 17/30

(52) U.S. Cl. 701/201; 701/200

(57) ABSTRACT

The system of the present invention provides easy update of a database containing a large amount of data arranged in a complicated interrelationship by use of a data file of a content limited to data differing from that already in the database, within a relatively short period of time. The system includes a navigation apparatus having a local storage database which contains, updated by a difference data file, a plurality of data groupings. The navigation apparatus determines conversion priority according to the operational state of an operation program and converts data in a local storage database to a referential data format in the order of the determined conversion priority. The system also includes a server apparatus for outputting the difference data file to the navigation apparatus.

### INCORPORATION BY REFERENCE

The disclosure of Japanese Patent Application No. 2006-269311 filed on Sep. 29, 2006, including the specification, drawings and abstract thereof, is incorporated herein by reference in its entirety.

### BACKGROUND

1. Field of Invention

The present invention relates to a data update system including a navigation apparatus which executes programmed operations and a server apparatus which provides current data for updating a database in the navigation apparatus, to the navigation apparatus, and to a data update method.

2. Description of the Related Art

Japanese Unexamined Application Publication (“Kokai”) No. 2006-84257 discloses a data update system in which a server transmits difference data to a terminal apparatus such as a navigation apparatus, and in which the terminal apparatus utilizes the received difference data to update the stored data to include a combination of previously stored information and the difference information.

The data update system described in Kokai No. 2006-84257 is an information delivery system comprising an information center for transmitting information and a terminal apparatus for receiving the transmitted information. The information center apparatus comprises a difference information extracting unit for identifying and extracting data different from information that has been previously transmitted to the terminal device, and a transmitter unit for transmitting the different information extracted through the different information extracting unit to the terminal apparatus. In addition, the terminal apparatus comprises a receiver unit for receiving the different information from the information center and a display unit for displaying the different information received through the receiving unit in combination with previously stored information (information not updated (replaced) by the different information).

The terminology “difference information” as used herein is traffic information such as that relating to traffic congestion or restriction, for example, data corresponding to a difference between the traffic information previously generated and the latest (most current) traffic information. The terminal apparatus that has received the foregoing difference information then displays on the display unit both the existing traffic information already received/stored in a storage unit and the difference information newly received. Consequently, it becomes possible to frequently update the traffic information for display on the terminal apparatus and also to minimize the volume of information transmitted from the information center to the terminal apparatus for updating.

### SUMMARY OF THE INVENTION

The data update system described above is a system designed to update data with a relatively reduced volume of information such as traffic information. Accordingly, if the difference data is generated at the server side (the information center) and transmitted to the navigation apparatus (the terminal) as described above, the data may be updated relatively easily, e.g., by rewriting existing data stored at the side of the navigation apparatus in accordance with the difference data. Further due to a reduced volume of information, the previously stored data may be updated within a relatively short period of time; and, therefore, the new information updated based on the difference data may be quickly provided to a user shortly after receiving the difference data (the difference information) for updating.

However, in the case of updating a database wherein the stored data has a very large volume and a complicated structure (interrelationship of stored items of data), such as a map database including road network data to be used in a navigation apparatus, it is not easy to update the database on the basis of the received difference data. In other words, with such complicated data, modifying one piece of data will necessitate modification of a number of items of data associated (correlated) therewith and, therefore, the volume of data included in the difference data will be increased accordingly. In addition, in order to update a database on the basis of the aforementioned difference data, a larger volume of non-updated data, corresponding to a large volume of data included in the difference data, also needs to be extracted from the database, resulting in a tremendous volume of extracted data. For example, in the case of updating a database storing road network data, each data item is arrayed in the order of the connection with the road network, so each of the data items included in the difference data cannot be extracted with ease. Therefore, the process of updating in the terminal apparatus is very complicated and takes too much time. Thus, in the case of updating a complicated database, such as a nap database being used in the navigation apparatus, generally all of the data must be rewritten and updated, instead of updating merely the difference, i.e., those items differing from the most current information. However, with such a method, the volume of the data necessary for updating is too great to transmit to a terminal apparatus through a communication network. Accordingly, the frequent updating of data is not feasible, and unfortunately it has been very difficult to continuously provide up-to-date data to a terminal apparatus.

If a navigation apparatus was to be provided with a database structure designed specifically for differential update, the process of differential update of the database might be relatively simplified. However, even with such a data structure, in the differential updating of a reference database to be used in execution of an operation program, the volume of data for the update is too great and it takes too much time to update all the data.

Accordingly, an object of the present invention is to provide a data update system, a terminal apparatus for the data update system, a server apparatus, and a data update method capable of easy differential update of a database containing a great volume of data having a complicated structure such as a map database including road network data and, after executing the differential update, providing new information based upon the updated database to a user within a relatively short period of time.

To achieve the aforementioned object, the present invention provides a data update system with a navigation apparatus being operated in accordance with a stored operation program and a server apparatus transmitting a difference data file for updating a database to the navigation apparatus. The navigation apparatus is provided with an update data format which is different from the reference data format utilized by the operation program. The data update system of the present invention includes:

a local storage database which is updated on the basis of the difference data file;

priority determination means for, after updating the local storage database, determining a conversion priority for a plurality of sets (groupings) of data stored in the local storage database according to operational state of the operation program, i.e. according to whether or not a guidance route has been determined or “set”;

conversion means for converting the data stored in the local storage database to the referential data format in the order of the conversion priority, and

difference data file output means, within the server apparatus, for outputting the difference data file to the navigation apparatus.

Accordingly, the navigation apparatus includes the local storage database containing data in an update data format that is suitable for updating by utilization of the difference data file. Therefore, the differential update may be performed relatively easily even for a database having a great volume of data wherein the relationship between data items (data structure) is complicated. Accordingly, the data may be updated with the difference data file more frequently and more easily, and up-to-date data may be provided to the navigation apparatus continuously. In addition, the data in the local storage database is used after being converted by the conversion means to the referential data format for use by the operation program. Therefore, by changing the format of the local storage database to the update data format, the influence of the operation program may be controlled. Further, after updating the local storage database, the data in the local storage database is then converted to the referential data format in the order of the conversion priority. Therefore, the data with higher conversion priority is converted to the referential data format, ahead of conversion of the other data, to make that higher priority data quickly available for use by the operation program. Thus, the proper determination of the conversion priority according to the state of the operation program enables provision of updated information for a set guidance route or guidance for the vicinity of the current location, for which a user may have an immediate need, within a short period of time after performing the differential update of the local storage database.

When a guidance route has been determined, it may be preferable that the priority determination means give a conversion priority to the data corresponding to the guidance route that is higher than the conversion priority given the other data.

Therefore, the data corresponding to the guidance route is converted to the referential data format before conversion of the other data, and thereby made available for use by the operation program. Accordingly, the information necessary for guidance along the set guidance route is provided within a relatively short period of time after the differential update of the local storage database.

When no guidance route has been set, it may be preferred that the priority determination gives higher conversion priority to the data for guidance pertaining to the vicinity of the current location than that given to the other data.

Therefore, in a case where a guidance route has not been set, the data corresponding to guidance for the vicinity of the current location is converted to the referential data format before such conversion of the other data to make that higher priority information more rapidly available for use by the operation program. Accordingly, the information necessary for guidance for the vicinity of the current location, when a guidance route has not been set, may be available for use within relatively a short period of time after the differential update of the local storage database.

The navigation apparatus may include a referential database, for storing the data in the referential data format to be referred to in execution of the operation programs, and a referential database update means for updating the referential database on the basis of the data converted by the conversion means.

Operation programs are executed by referring to the referential database which stores the data in the referential data format. Accordingly, the processing load on the conversion means may be reduced as compared to a system in which all the data to be used by the operation programs is converted by the conversion means each time an operation program is executed. Further, the content of the referential database may be updated to match the content of the local storage database which is updated by the difference data file.

For data having a conversion priority of higher than a predetermined level, the referential database update means updates the referential database preferentially after conversion by the conversion means, and if the data has lower priority than the predetermined level, the referential database update means updates the referential database in parallel with a guidance operation by execution of the operation program. The terminology “guidance operation” is intended to include all the operations involved in providing the guidance function of the navigation apparatus, such as display of the current location, determining (calculation) of a route, from a starting point to a destination, course guidance to a destination, searching for a destination, etc.

As noted above, for the data with a conversion priority higher than a predetermined level, the referential database is updated preferentially. Thus, when setting the conversion priority higher for data corresponding to the information the user may need, such as the set guidance route or guidance for the vicinity of the current location, for example, the update of such higher priority information is incorporated into the referential database within relatively a short period of time after the differential update of the local storage database and thereby made available to the user. On the other hand, for the data with lower conversion priority, to avoid disturbing a guidance operation (execution of an operation program), the referential database is updated in parallel with the guidance operation. The content of all the data updated on the basis of the difference data file is eventually incorporated into the referential database.

In another embodiment the data stored in the local storage database includes the road network data, the referential data format is in the data format in which the road network data is arrayed in the order of the connection of each grouping of the data, and the update data format is an array of the road network data arranged in the order of the data categories.

The data format of the local storage database may be the format which is suitable for updating with the difference data file, and the data converted by the conversion means may be in the format which is suitable for utilization in execution of the operation program in the navigation apparatus. Thus, the differential update of the road network data, which is a very large volume of data and which has a complicated interrelationship, may be performed relatively easily, while the influence on execution of the operation program may be controlled so as to ensure that the operation of the navigation apparatus continues to be properly performed.

The difference data file preferably includes data representing an update mode and the road network data corresponding to that portion of stored data targeted for update may be in the data format in which data is arrayed in the order of the data categories.

In the aforementioned structure, substantive data which is targeted for update is sorted on the basis of the update mode and is in the data format in which it is arrayed in the order of the data category, i.e., the same as the update data format of the data in the local storage database. Therefore, the process of the differential update of the local storage database may be performed relatively easily using the difference data file.

The data stored in the local storage database preferably includes the road network and route pre-calculation data obtained by pre-calculation of plural routes between a starting area and a destination area, wherein the difference data file includes the data representing the update mode, the road network data corresponding to the portion of the stored data targeted for update, and the pre-calculation data corresponding the that portion of data targeted for update. Note that the present invention does not limit the “departing area” or “destination area” to an area having a certain expanse, but also includes one point or a group of two or more points.

The differential update of the local storage database may also be performed for the route pre-calculation data, as well as the road network data.

In the case where a guidance route has been set, within the route pre-calculation data, the priority determination means may set the conversion priority for the data corresponding to the guidance route connecting the departing area and the destination area higher than that for other data.

Where the navigation apparatus stores the route pre-calculation data and also data for a set guidance route, the route pre-calculation data corresponding to the guidance route is converted to the referential data format before conversion of the other route pre-calculation data, thereby making it available for use in the operation program. Accordingly, the route pre-calculation data required in connection with a guidance route already set in the navigation apparatus may be made available within relatively a short period of time after the differential update of the local storage database.

The server apparatus may include a comparative local storage database which has stored therein the same content as the local storage database, a new data accepting means for accepting input of new data, and a difference data file generation means for generating the difference data file on the basis of the data in the comparative local storage database and the new data.

In accordance with the present invention, the server apparatus may easily generate the difference data file based on the input of new data and the content of the local storage database in the navigation apparatus.

The server apparatus may further include a new local storage database generation means for, on the basis of the data in the comparative local storage database and the new data, updating the new local storage database with the new data in the same data format as the comparative local storage database. Alternatively, the difference data file generation means may generate the difference data file on the basis of the difference between the comparative local storage database and the new local storage database.

Because the difference data file is generated on the basis of the database of before/after the update in the same data format as the local storage database in the navigation apparatus, the difference data file may be generated relatively easily in a format that is suitable for the update of the local storage database.

The navigation apparatus accepts the difference data file from the server apparatus for updating its database while executing an operation program. The navigation apparatus has a local storage database in an update data format which is different from the referential data format which is utilized in execution of the operation program, the local storage database being updated with the difference data file. The navigation apparatus may further include the priority determination means for, after updating the local storage database, determining the conversion priority for the groups of data stored in the local storage database according to the state of the operation of the operation program, and the conversion means for converting the data stored in the local storage database to the referential data format in the order of the conversion priority.

Accordingly, by utilizing a local storage database in an update data format that is suitable for updating with the difference data file, even with a database containing a large and complicated body of data, the differential update may be performed relatively easily. Thus, frequent updating becomes relatively easy with the difference data file and the most current data may be continuously provided to the navigation apparatus. In addition, the data in the local storage database is used after being converted by the conversion means to the referential data format, a format which is readily utilized in execution of an operation program. Therefore, the influence on the execution of the operation program, when the local storage database has the update format, may be controlled. Further, because the newly updated data in the local storage database is converted to the referential data format in the order of a conversion priority, the data with higher conversion priority is converted to the referential data format before conversion of the other data, that higher priority data more quickly becomes available for use by the operation program. Thus, the proper determination of the conversion priority according to the state of the operation of the operation program enables quick availability of that updated information, such as the information for the set guidance route or guidance for the vicinity of a current location that a user may need shortly after the differential update of the local storage database.

Further, it may be preferred to combine each of the functions of the navigation apparatus described above, with all the advantages as described above.

The present invention also provides a data update method utilizing the difference data file communicated from the server apparatus to the navigation apparatus to update its database. In the update method of the present invention, with the server apparatus and/or the navigation apparatus having a local storage database in an update data format which is different from the referential data format which can be utilized by the operation program, the server apparatus outputs the difference data file to the navigation apparatus, and the navigation apparatus accepts the difference data file, updates the local storage database with the difference data file, and after updating the local storage database, determines the conversion priority for groupings (“groups” or “items”) of data stored in the local storage database according to the state of the operation of the operation program, converts the data stored in the local storage database to the referential data format in the order of the conversion priority, and makes the converted data available for use in execution of the operation program.

As previously described, the navigation apparatus may include the referential database that contains the data in the referential data format for use by the operation program and may update the referential database with the data which has been converted to the referential data format.

It may be preferred that the server apparatus includes the comparative local storage database which carries the same content as the local storage database, accepts the input of new data, and generates the difference data file on the basis of the comparative local storage database and the new data.

### BRIEF DESCRIPTION OF THE DRAWINGS

Preferred embodiments of the present invention will now be described with reference to the accompanying drawings, wherein:

FIG. 1 is a block diagram of a preferred embodiment of a data update system in accordance with the present invention.

FIG. 2 is a diagram of one example of a navigation program utilized in the present invention.

FIG. 3 is a diagram of the structure of one example of a referential database.

FIG. 4 is a diagram showing the structure of one example of road network data and, in particular, the relationship between different layers in one section of the road network data.

FIG. 5 is a diagram of one example of a road network.

FIG. 6 is a diagram of the structure of one example of road network data in a referential data format.

FIG. 7 illustrates a process of route determination.

FIG. 8 is a diagram showing an example of route pre-calculation data.

FIG. 9 is diagram shown the structure of one example of a difference data file.

FIG. 10 is a diagram of one example of road network data in an update data format.

FIG. 11 is a diagram of one example of route pre-calculation data in an update format.

FIG. 12 is a comparative table of a record code and a permanent ID for items of data.

FIG. 13 is a flowchart of a preferred embodiment of a routine for generating a difference data file.

FIG. 14 is a flowchart of a preferred embodiment of a routine for transferring a difference data file to a navigation apparatus.

FIG. 15 is a flowchart of a preferred embodiment of a routine for updating a referential database in a navigation apparatus.

### DESCRIPTION OF PREFERRED EMBODIMENTS

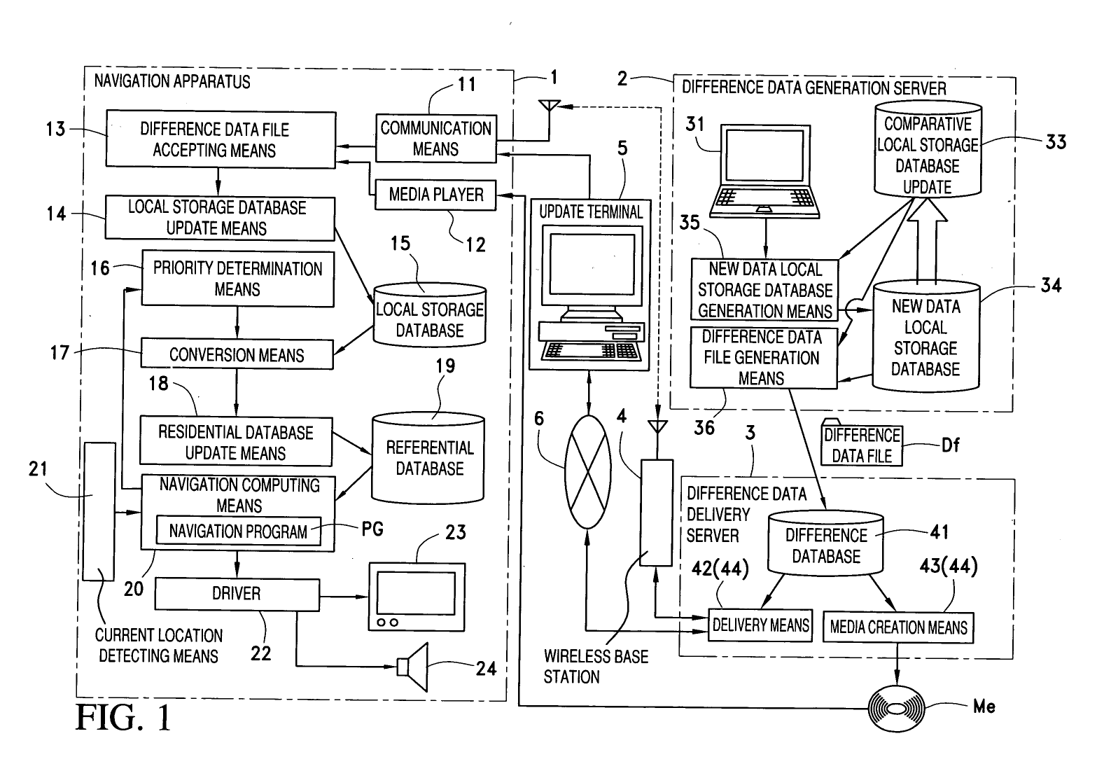

One embodiment of the present invention is shown in FIG. 1 as including a difference data generation server 2 for generating a difference data file Df and a difference data delivery server 3 for transferring the generated data file Df to a navigation apparatus 1 wherein it is utilized for updating a referential database 19 serving as a navigation map database. The “server” in this embodiment is comprised of the difference data generation server 2 and the difference data delivery server 3.

In the navigation apparatus 1, the difference generation server 2 and the difference data delivery server 3 each include or share a functional unit for executing various routines utilizing inputted data, such as a CPU serving as the core component of the hardware and software. Each of the databases in the navigation apparatus 1, the difference data generation server 2, and the difference data delivery server 3 includes a rewritable memory medium such as a hard drive or a flash memory, for example, and a unit for driving same. Note that “DB” in each of figures in the present embodiment denotes “database”. Each apparatus component will be described hereinafter.

1. The Guidance Function of the Navigation Apparatus 1.

The navigation apparatus 1 includes a navigation computing means 20, the referential database 19, current location detecting means 21, a driver 22, a display unit 23, and an audio output unit 24 for output of basic guidance. The navigation apparatus functions to display a current location, to calculate (determine) a route from a departing point to a destination, to provide guidance to the destination, to search for a destination, and so forth.

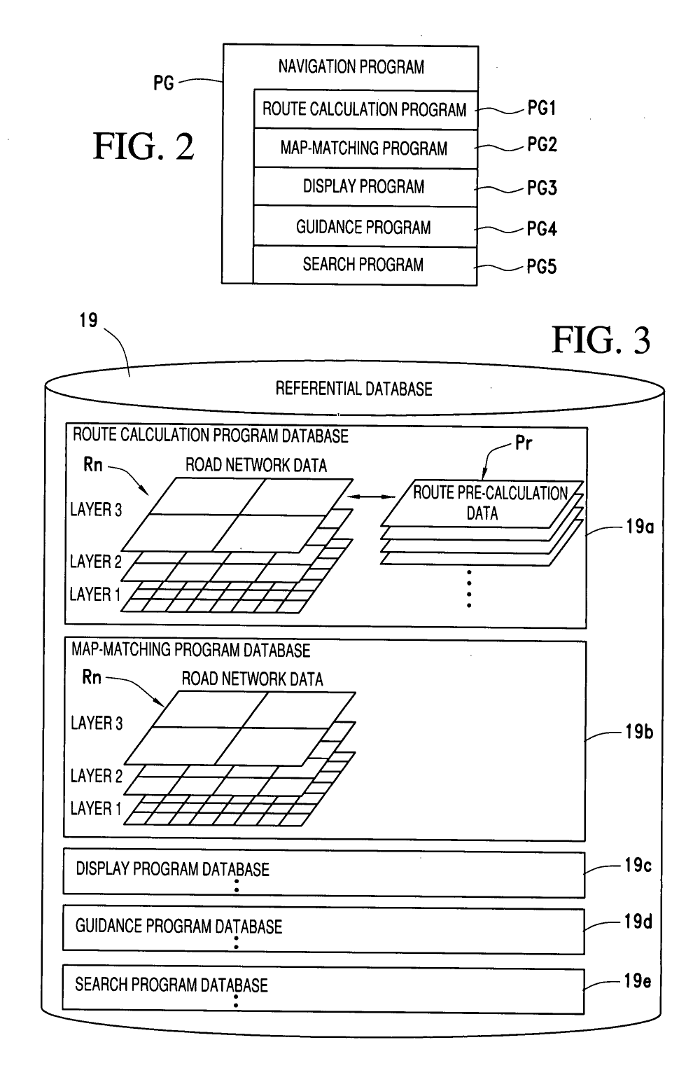

The navigation computing means 20 is operated in accordance with a navigation program PG (operation program). As shown in FIG. 2, the navigation program PG includes a plurality of application programs PG1, PG2, PG3, PG4 and PG5. In the present embodiment, the navigation program PG includes the following five application programs: a route calculation program PG1, a map-matching program PG2, a display program PG3, a guidance program PG4, and a search program PG5. The route calculation program PG1 is a program for searching to determine a route from a departing point (current location) to a destination that have been inputted through the display operation unit 23. The map-matching program PG2 is a program for matching a current location detected by the current location detecting means 21 with a road on a map. The display program PG3 is a program for displaying a map of the area (vicinity) around a current location or a destination point or displaying the current location on a map on the display screen of the display unit 23. The guidance program PG4 is a program for providing video route guidance on the display screen of the display unit 23 and/or audio route guidance through the audio output unit 24, for travel along the route to the destination determined by execution of the route calculation program PG1. The search program PG5 is a program for searching for a destination or any given point for display on a map, responsive to input of an address, a phone number, a facility name, or a genre. An outline of the route search routine, i.e. the route calculation program PG1, will be described hereinafter. The routines executed by the navigation apparatus 1 on the basis of the other application programs PG2, PG3, PG4 and PG5 are well known, and therefore a detailed explanation will not be given here. Each application program PG1, PG2, PG3, PG4, and PG5 may use the data (information) stored in the referential database 19, such as road network data Rn and route pre-calculation data Pr.

The referential database 19 is a database which stores data in a referential data format to be used in execution of the navigation program PG to provide the above-described basic guidance functions of the navigation apparatus 1, and which stores navigation map data such as the road network data Rn and the route pre-calculation data Pr, thus serving as a navigation map database. In addition, the referential database 19 includes a plurality of databases for each of the plurality of application subroutines included in the navigation program PG. FIG. 3 is a diagram showing one example of a referential database 19 wherein each item of data of the road network data Rn and the route pre-calculation data Pr in the referential database 19 is stored in correlation with an application program PG1, PG2, PG3, PG4, and PG5, and each serves as an application program database 19a, 19b, 19c, 19d or 19e. Thus, in the present embodiment, the referential database 19 includes a route calculation program database 19a, a map-matching program database 19b, a display program database 19c, a guidance program database 19d, and a search program database 19e.

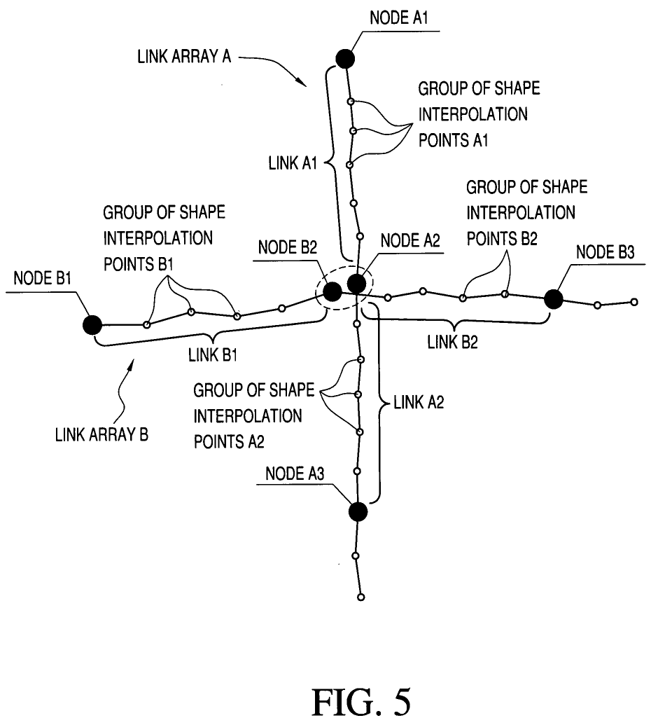

Though partially omitted in FIG. 3, at least the road network data Rn is stored in the referential data format corresponding to the respective application programs PG1, PG2, PG3, PG4, and PG5 and respectively stored in the application program databases 19a, 19b, 19c, 19d, and 19e. In addition, the route calculation program database 19a stores the route pre-calculation data Pr in correlation with the road network data Rn. The content of the route pre-calculation data Pr will be described hereinafter. Further, each of the application databases 19a, 19b, 19c, 19d, and 19e stores various data (guidance data) for display, guidance, route searching, and so forth, required for execution of the corresponding application program PG1, PG2, PG3, PG4, or PG5, in addition to the road network data Rn and the route pre-calculation data Pr (not illustrated). Such data includes, for example, image data, audio data, and/or POI (Point of Interest) data, and each item of the data is stored in association (correlation) with data for links or nodes included in the road network data Rn. (see FIG. 5).

As shown in FIG. 3, in the present embodiment the road network data Rn in each application database 19a, 19b, 19c, 19d, and 19e, within the referential database 19, is divided into a plurality of layers (hierarchy) according to the amount of detail of the stored road information. In the present embodiment, the road network data Rn has three layers, layer 1, layer 2, and layer 3, from the lower level to the upper level. The lower level includes the most detailed road information. In particular, each layer stores the information of the road category as follows. For example, the layer I stores information of a) a highway and a toll road, b) a national road, c) a state road, d) a principal regional road, and e) a general local road. The layer 2 excludes e) general local roads and stores information for a) highways and toll roads, b) national roads, c) state roads, and d) principal regional roads. The layer 3 further excludes c) state roads and d) principal regional roads and stores information for a) highways and toll roads and b) national roads.

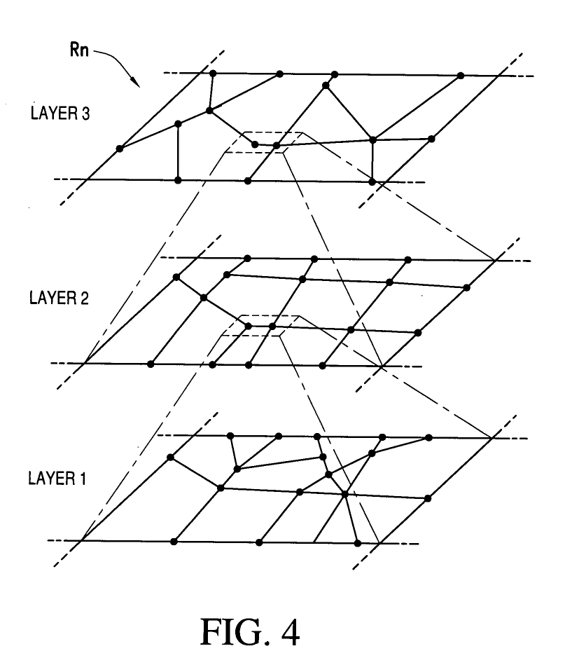

As shown in FIG. 3, each layer is divided into a plurality of sections. The upper layer includes the sections corresponding to a wider area. FIG. 4 is a diagram showing the relationship between the different layers of one section in the road network data Rn. As shown in this figure, one section in the upper layer includes a region corresponding to a plurality of sections in the lower layers. As further shown in FIG. 3, the road network data Rn stored in each of the application program databases 19a, 19b, 19c, 19d, and 19e is a subgroup of road network data Rn for the corresponding sections in the plurality of sections into which each layer is divided. Each section in each layer is assigned a different section ID and the section ID enables extraction of road network data Rn for a specific section of a specific layer. Thus, as used herein, the word “section” refers to one of the plurality of sections into which each layer is divided.

FIG. 5 is a diagram showing an example of a road network as represented by the various sections of road network data Rn. In the example shown in this figure, a link array A and a link array B respectively include nodes A1, A2, A3 and B1, B2 and B3 (black filled circles in FIG. 5), with links A1, A2, B1, and B2 connecting two nodes (solid lines in FIG. 5), and a group of shape interpolation points specifying a shape of each of the links A1, A2, B1 and B2 (open circles in FIG. 5). The road network data Rn is the sum of the data for each of these link arrays. Note that, although the node A2 in the link array A and the node B2 in the link array B are represented at different locations in FIG. 5, they indicate the same intersection. In the road network data Rn, the data corresponding to each of the nodes is managed as part of link arrays A and B, and therefore, both link arrays A and B have the data for a node at the same intersection. Note that, in such case as above, the data also has the information of the data array of the other node indicating the same intersection.

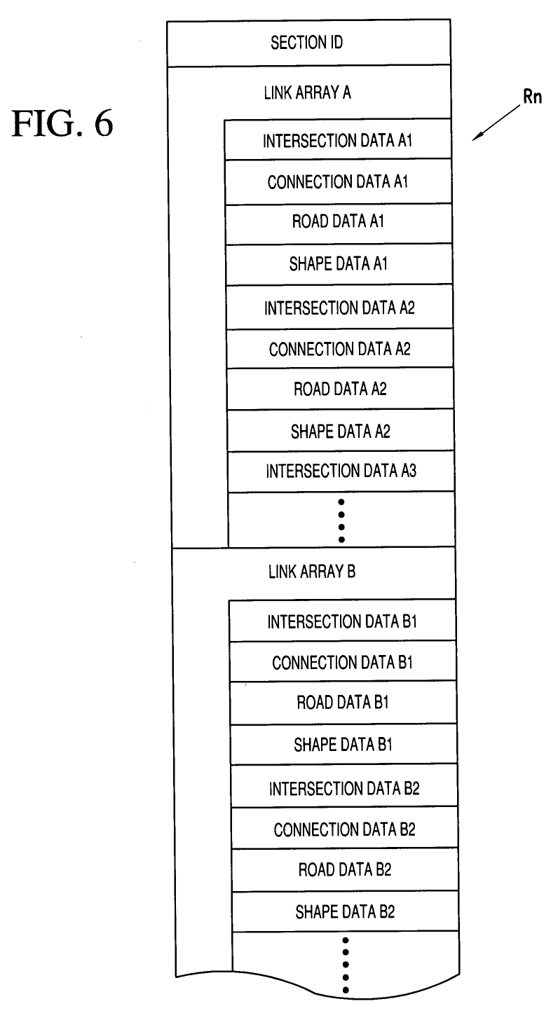

FIG. 6 is a diagram of an example of the structure of the road network data Rn in the referential data format which represents the road network shown in FIG. 5. As shown in this figure, the referential data format is a data format wherein each item of data is arrayed in the order of its connection in the road network in the present embodiment, as described above, each of the sections in each layer is assigned a different section ID, and a section ID is at the top of the road network data Rn structure for each of the sections. In addition, the road network data Rn includes intersection data, connection data, road data, and shape data. The intersection data includes coordinates of nodes indicating intersections, information indicating the existence or nonexistence of a traffic signal or a traffic sign at an intersection, and information as to hierarchy indicating the uppermost layer among the plurality of layers (layer 1 to layer 3) in which the intersection (node) is included. The connection data includes information regarding the roads (links) connected to the node at the intersection, information regarding the necessity of guidance at the intersection, information regarding regulation of traveling direction at the intersection, and so forth. The road data includes information regarding nodes located at the ends of the links of the road, information identifying the road category, information for roadway width, information on the number of traffic lanes, hierarchy information indicating the highest layer among a plurality of layers (layer 1 to layer 3) in which the road (link) is included, and so forth. The shape data includes coordinates of a group of shape interpolation points, specifying the shape of a link, and so forth. As for the information of the hierarchy of the intersection data and the road data in the present embodiment, the data for intersections (nodes) and road links in a) highways and toll roads and b) national roads, is included in all the layers 1 to 3, while data for intersections (nodes) and the road links in c) state roads and d) principal regional roads, is included in layer 1 and layer 2, and data for intersections (nodes) and the road links in e) general local roads, is included only in layer 1. Note that each of the data categories, i.e., intersection data, connection data, road data, shape data, same type of content in the update data format stored in the local storage database 15 and in the road network data Rn included in the difference data file Df. However, each of the specific contents or arrays differs to a certain degree. For example, neither the road extension data nor the intersection extension data in the update data format are a separate independent category in the road network data Rn stored in the referential database 19 but, instead, are included in any one of the intersection data, the connection data, the road data, and the shape data.

Data items are arrayed in the order of their connection within the road network. More specifically, each item of data is arrayed in the order of the connection of the nodes and the links for each link array. For example, the data corresponding to the link array A shown in FIG. 5, is structured with the intersection data A1 and the connection data A1 corresponding to the node A1 located at the top, below which is the road data A1 corresponding to the link A1 which is connected to the node A1, and the shape data A2 corresponding to the shape interpolation points on the link A1, as shown in FIG. 6. Next, below the foregoing data, is the intersection data A2 and the connection data A2 corresponding to the node A2, which is connected to the other end of the link A1, followed by the road data A2 corresponding to the link A2, and the shape data A2 corresponding to the group of the shape interpolation points on the link A2. The other link arrays, such as the link array B, are arranged (structured) in the same manner. Note that the specific content of each data category included in the road network data Rn differs according to in which application program database 19a to 19e the data is stored; however, the structure (organization) of the data as shown in FIG. 6 is the same in all application program databases 19a to 19e.

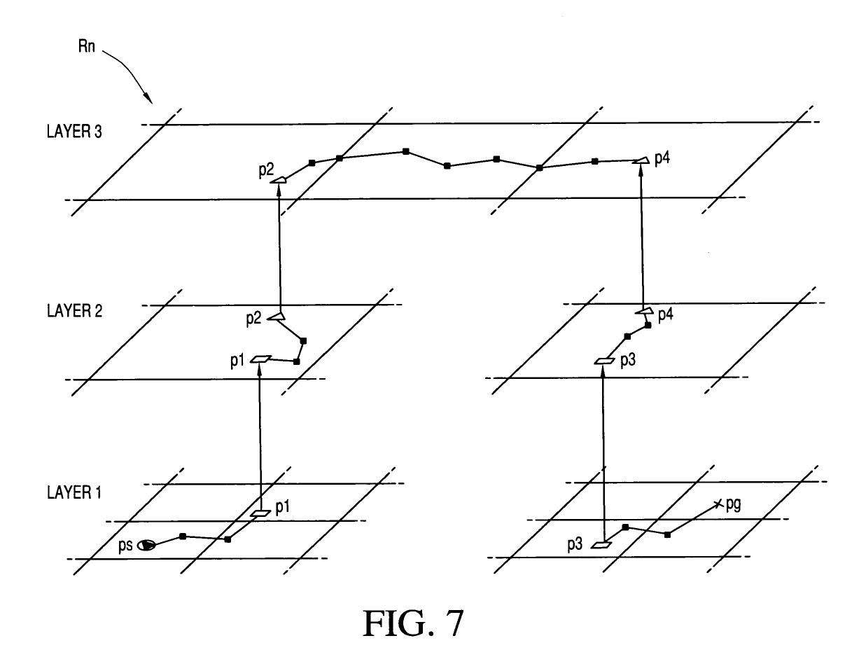

The navigation computing means 20 determines a route from the current location to a destination, utilizing the above-described road network data Rn, in execution of the route calculation program PG1. FIG. 7 gives an overview of the processing in execution of the route calculation program PG1, to determine a route from the point of departure ps (starting point) shown in the lower left portion of the figure, to the destination pg. As shown in this figure, the process of route determination, on the basis of the road network data Rn in layer 1, which includes the most detailed road information, searches for a route to a common intersection (node) p1 which is also included in the road network data Rn in the layer 2 and which is the starting point ps. Next, a route to a common intersection (node) p2, which is also included in the layer 3, is searched for on the basis of the road network data Rn in layer 2. Likewise, around the destination pg, on the basis of the road network data Rn in layer 1, a search is made to determine a route to a common intersection (node) p3 which is also included in the road network data Rn in the layer 2. Next, on the basis of the road network data Rn in the layer 2, a route to a common intersection (node) p4 which is also included in the layer 3 is determined. Then, on the basis of the road network data Rn in layer 3, a route connecting an intersection (node) p2 and p4 is searched for with a highway, a toll road, a national road, as a target. The search for a route from a starting point ps to a destination pg is thereby completed.

The route pre-calculation data Pr is obtained by the pre-calculation of plural combined routes between a departing area and a destination area through execution of the route calculation program PG1. In the present embodiment, the “departing area” and the “destination” area are each a “section” in the road network data Rn in layer 2. That is to say, the section in the layer 2 which includes the starting point ps (see FIG. 7) represents the “departing area”, and the section in the layer 2 which includes the destination pg (see FIG. 7) represents the “destination area”. The route pre-calculation data Pr is the data obtained as the result of the pre-calculation of the route connecting two nonadjacent sections in the layer 2 on the basis of the road network data Rn in layer 3.

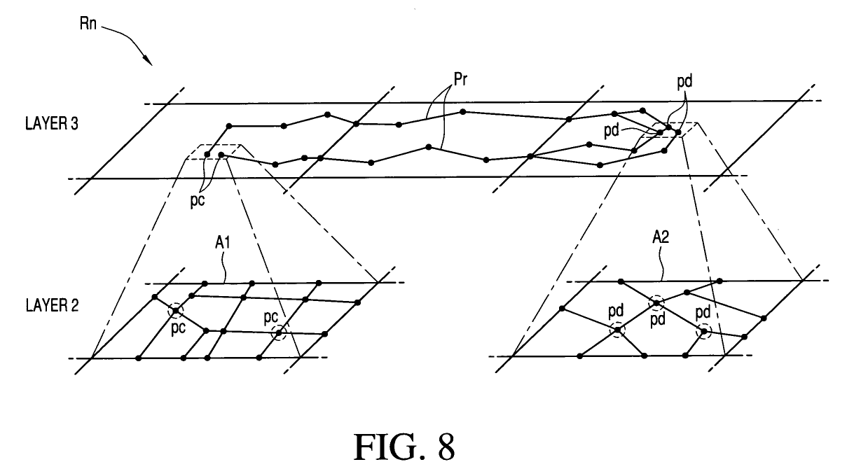

FIG. 8 is a diagram of one example of route pre-calculation data Pr. As shown in this figure, the route pre-calculation data Pr for connection of section A1 and section A2 is the layer 2, respectively representing departing area and destination area, may be for a plurality of alternative routes connecting a common intersection (node) pc included in common in the layer 3 for the section A1 and a common intersection (node) pd which is also included in the layer 3 for the section A2. In the example shown in FIG. 8, the section A1 includes two intersections (nodes) pc which are also included in the layer 3 (“common intersections”), and the section A2 includes three intersections (nodes) pd which are also included in the layer 3, and, accordingly, six routes may be determined as the route pre-calculation data Pr. Note that occasionally a route determined as described above may partially or fully overlap another route. As described above, the route pre-calculation data Pr may be organized in the order of the connection of the nodes and the links included in the road network data Rn in the layer 3 (see FIG. 5).

The remainder of route pre-calculation data Pr is calculated in the same way for all combinations of the sections in the layer 2. Thus, the results of search (calculation) for routes between one section in the layer 2 and all the other sections that are nonadjacent to the section in the layer 2 become the route pre-calculation data Pr for the one section. For example, the route pre-calculation data Pr for the section A1 in FIG. 8 is for a group of routes between the section A1 and all the other sections that are nonadjacent the section A1 in the layer 2. Likewise, route pre-calculation data Pr for all the sections in the layer 2 are stored, by section, in the route calculation program database 19a of the referential database 19 (see FIG. 3). In the route calculation program database 19a, the route pre-calculation data Pr is stored in the referential data format associated with the road network Rn so as to be read easily when performing a route search by execution of the route calculation program PG1.

With the foregoing route pre-calculation data Pr, the navigation computing means 20 is able to search for a route from the starting point ps to the destination pg without utilizing only the road network data Rn in the layer 3. Instead, as shown in FIG. 7, a route from the departing point ps to the intersection (node) p2 is searched while a route from the destination point pg to the intersection (node) p4 is searched, then the navigation computing means 20 extracts the route pre-calculation data Pr for a route, which connects the intersections (nodes) p2 and p4 from the referential database 19. Thus, a search for a route from ps to pg utilizes pre-calculation data for that portion of the route which connects the intersections (nodes) p2 and p4, and accordingly shortens the time and decreases the computing load for route determination. Stated differently, by utilizing the pre-calculation data, a search for a route from ps to pg need not include a search for route segments linking nodes p2 and p4.

The current location detecting means 21 in the navigation apparatus 1 detects a current location. Therefore, the current location detecting means 21 includes, for example, a GPS receiver, a direction sensor, a distance sensor and so forth (not illustrated). The current location detecting means 21 obtains information, e.g. coordinates and/or traveling direction indicating the current location, and outputs it to the navigation computing means 20. The display unit 23 includes a display screen such as a LCD or the like and a touch panel or an input operation unit controlling the display screen. The audio output unit 24 includes a speaker, an amplifier and so forth. Each of the display unit 23 and the audio output unit 24 is connected to the navigation computing means 20 through the driver 22 and operates to provide a visual display or voice output identification of the current location, a route between two points, course guidance, a destination search and so forth. In addition, the display unit 23 accepts input from a user and outputs that user input to the navigation computing means 20.

2. The Update Function of the Navigation Apparatus 1.

In addition to features for providing the basic guidance functions described above, the navigation apparatus 1 includes a communication means 11, a media play means 12, a difference data file accepting means 13, a local storage database update means 14, a local storage database 15, a priority determination means 16, a conversion means 17, and a referential database update means 18 for updating the referential database 19. The latter updating involves, first, a differential update of the local storage database 15 based on the difference data file Df provided by the difference data delivery server 3 and then updating the referential database 19 by converting the data in the updated local storage database 15 to the referential data format. Each of these operations will be described in detail below.

The difference data file accepting means 13 accepts the difference data file Df provided by the difference data delivery server 3. In the present embodiment, the difference data file Df is accepted through the communication means 11 or through the media player 12. In the present embodiment the communication means 11 may receive the difference data file Df via radio transmission from a wireless base station. This wireless communication may utilize a mobile phone network, a wireless LAN (Local Area Network), or any other well-known communication network. In addition, the communication means 11 is able to communicate with an update terminal 5 carried by a user or a service provider for the navigation apparatus 1 and is able to transfer to the update terminal 5 the difference data file Df through a communication network 6 such as the internet. The update terminal 5 may be a personal computer or the like, and various conventional wired or wireless communication methods may be used for communication between the communication means 11 and the update terminal 5. The media player 12 is for playing a memory media created in the difference data delivery server 3 and for reading the difference data file Df stored in the memory media. Note that the difference data file accepting means 13, when receiving the difference data file Df from the difference data delivery server 3 through the communication means 11 or reading the difference data file Df from the memory media by the media player 12, accepts only the most current version of the difference data file Df not already included in the road network data Rn stored in the local storage database 15.

The difference data file Df is a file that gathers the data for updating based on the actual current state of a road or facility, as “difference data”, i.e., that data different from corresponding data stored in the referential database 19 of the navigation apparatus 1. The difference data file Df is generated at the difference data generation server 2 on the basis of newly received data and a comparative local storage database 33 that has the same content as the local storage database 15 in the navigation apparatus 1.

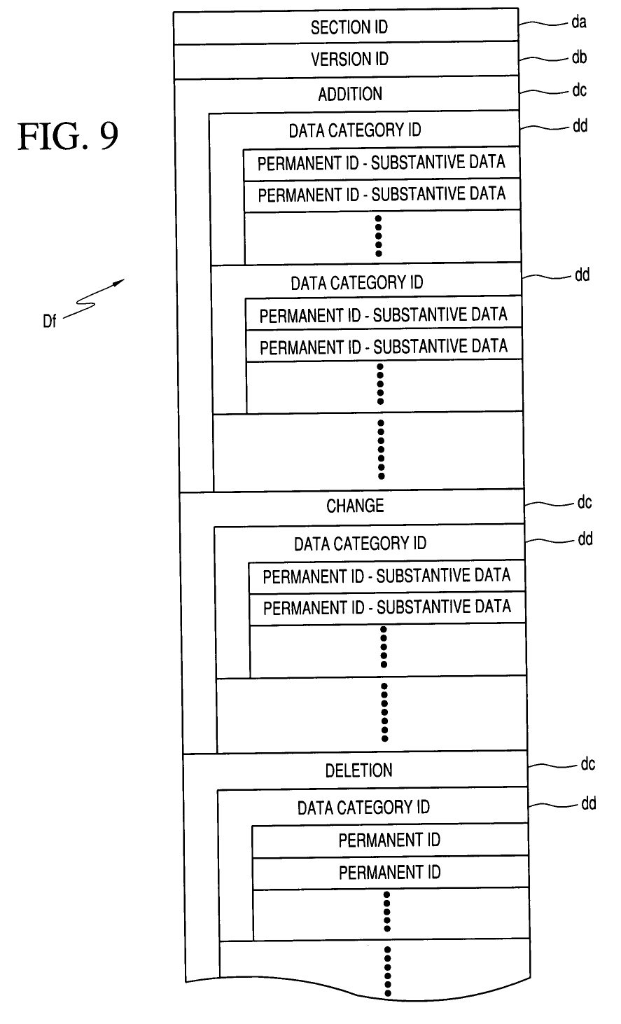

FIG. 9 is a diagram showing one example of a difference data file Df. In the present embodiment, a difference data file Df is created for each of the sections in the road network data Rn and the route pre-calculation data Pr (see FIG. 3, FIG. 4, and FIG. 8), and section ID data da, indicating the corresponding section, is located at the top of the data structure. The difference data file Df also includes version data db representing an update version. Subsequently, the data for the difference data file Df is sorted to identify target data in the local storage database 15 (33) for update on the basis of the update mode. Thus, located at the top of the structure of each data set (group or “item”) sorted on the basis of the update mode, is update mode data dc indicating, as a mode, “addition”, “change” or “deletion”. Further, the difference data file Df has the data of the update mode arrayed in the order of the data categories. Therefore, at the top of each such data array is data category ID data dd indicating the data category of the data. The data category ID data dd is followed by permanent ID data and substantive data associated with it. The data for which updated mode is “deletion” receives no new substantive data and therefore, only the permanent ID data is included. The permanent ID is a unique ID which is assigned to each grouping of the substantive data included in the road network data Rn or grouping of the route pre-calculation data Pr in a specific map database. The above-described data structure is also used in the referential database 19 and in the local storage database 15.

The different data file Df mainly includes data for the road network data Rn, route pre-calculation data Pr, and data for a display, guidance, searching, and so forth (data for guidance). More specifically, the data category for network system data, which is a main portion of the road network data Rn, includes “intersection data”, “connection data”, “road data”, “shape data” and so forth. Additional data which is related to the network system data for the road network data Rn includes the road extension data and the intersection extension data. The data category for the road extension data includes, e.g., “road name data” or “traffic information related data” for association of the traffic information, such as that from a VICS (Vehicle Information and Communication System), with the road data. The intersection extension data category includes, e.g., “intersection name data” and/or “intersection guidance data” that represents the permanent ID of the guidance data indicating whether or not guidance is necessary at the intersection and, if yes, the guidance for that intersection, and so forth. As described above, in the present embodiment, the road network data Rn is categorized as “intersection data”, “connection data”, “road data”, “shape data”, “road name data”, “traffic information related data”, “intersection name data”, or “intersection guidance data”, and the data is arrayed in the order of the data category. Note that the structure of the difference data file Df may also be applied to the road network data Rn stored in the local storage database 15. The route pre-calculation data Pr is collected within the single data category “route pre-calculation data”. A data category ID is assigned to each of the data categories and included in the difference data file Df as the category ID data dd.

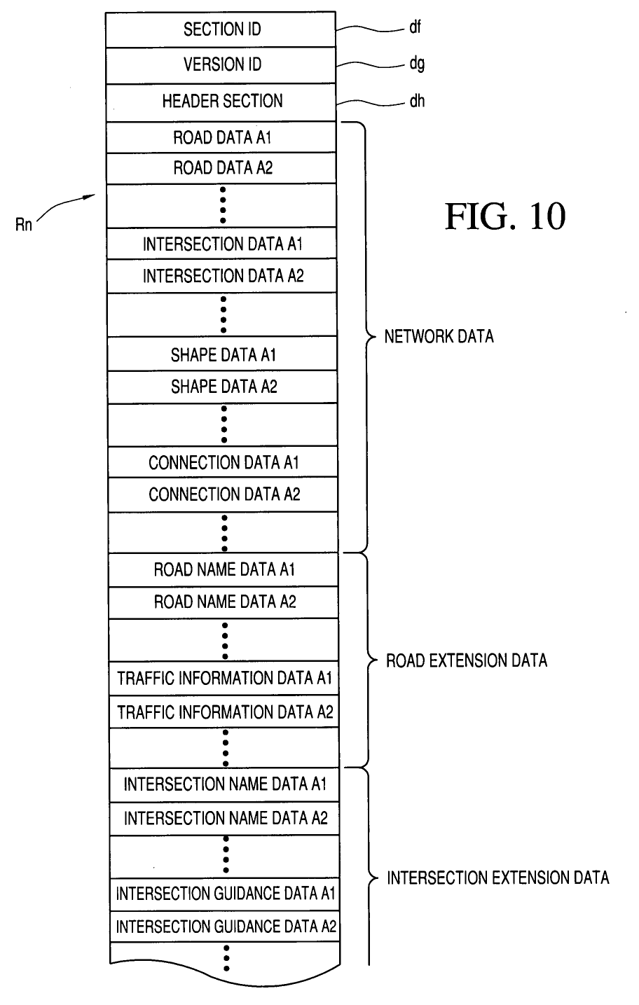

As shown in FIG. 1, the local storage database 15 is the database for the differential update of the navigation map data such as the road network data Rn, the route pre-calculation data Pr, and so forth. Thus, the data stored in the local storage database 15 is in the update data format which is different from the referential data format stored in the referential database 19. FIG. 10 is a diagram showing one example of road network data Rn in the update data format. As shown in the diagram, the update format has the data groupings arrayed in the order of data category. In the present embodiment, as in the case of the referential database 19, the road network data Rn in the local storage database 15 is divided into sections and the section ID data df indicating the section is located at the top of the data array. In addition, the road network data Rn includes version data dg identifying the update version. Further, the road network data Rn includes a section header dh in the form of address data representing the location of the substantive data in the road network data Rn. The header section dh is followed by the substantive data which is arrayed in the order of data categories.

The road network data Rn stored in the local storage database 15 in the update data format, as well as the difference data file Df, includes (1) “intersection data”, “connection data”, “road data”, “shape data”, and so forth as data categories, (2) “road name data”, “traffic information related data” and so forth as the road extension data, and (3) “intersection name data”, “intersection guidance data” and so forth as intersection extension data. The data groupings are arrayed in the order of the data category and the data within one data category is arrayed consecutively. More specifically, as shown in FIG. 10, all the road data is arrayed consecutively starting from the top with the road data for link A1, the road data for link A2 and so forth, followed by all the intersection data arrayed consecutively starting with the intersection data A1, then the intersection data A2 and so forth, and subsequently the data for all the other data categories. The header section dh is the address data indicating a region within a data category. Accordingly, the local storage database update means 14, by referring to the information stored in the header dh, may obtain the information of each data grouping in the local storage database 15.

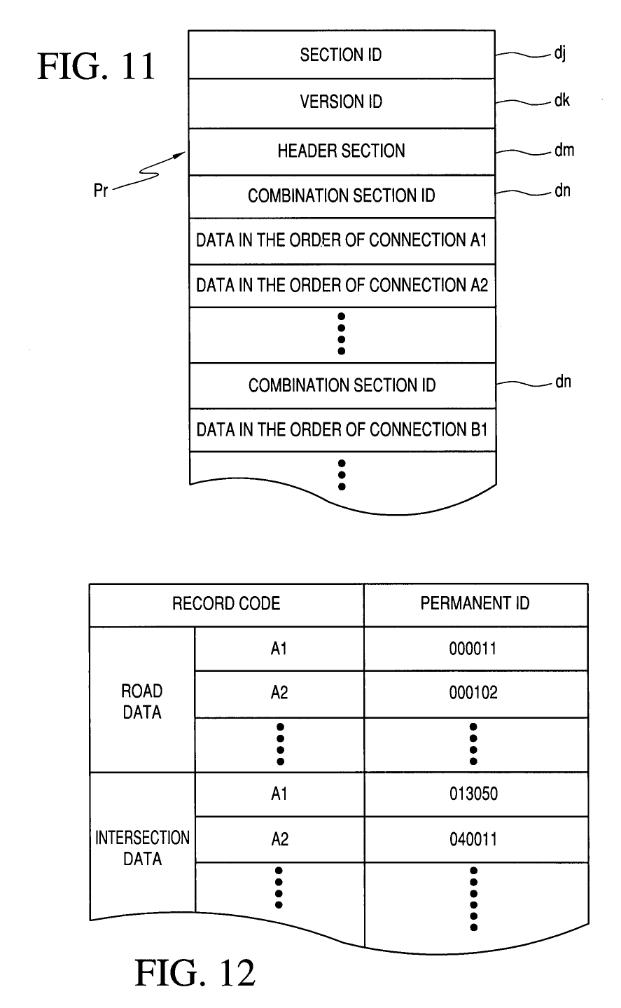

The local storage database 15 also stores the route pre-calculation data Pr. FIG. 11 is a diagram showing one example of route pre-calculation data Pr stored in the local storage database 15. In the present embodiment, the route pre-calculation data Pr is stored in a format independent from the road network data Rn, i.e., in the update data format for the route pre-calculation data Pr. The route pre-calculation data Pr is arranged by section in the layer 2 and the section ID data dj indicating the section in the layer 2 is at the top. Herein, the route pre-calculation data Pr corresponding to one section is a group of the route pre-calculation data Pr for routes between that one section and all the other nonadjacent sections in the layer 2, as in the case of the route pre-calculation data Pr stored in the route calculation program database 19a. In addition, the route pre-calculation data Pr includes version data dk which identifies the update version. Further, the route pre-calculation data Pr includes header sections dm with address data representing the substantive data alignments of the route pre-calculation data Pr. Each header section dm is followed by substantive data. Thus, the substantive data is sorted by section in the layer 2, with the sections each identified by section ID data dj and arrayed in order. That is to say, the substantive data includes the data which is the section ID data dj identifying a section in the layer 2 and combination section ID data dn representing the section ID for other section and data groupings A1, A2, and so forth, in the order of the connection of the nodes and the links (see FIG. 5) included in the route between these two sections (the section identified by section ID data dj and the other section identified by the combination section ID data dn). Note that the combination of these data groupings in the order of connections is the data representing one route. Further, various items of guidance data such as image data, audio data, POI (Point of Interest) data and so forth are stored in the local storage database 15 in the order of the data categories (not illustrated).

As shown in FIG. 12, the local storage database 15 stores a table with a record code and a permanent ID for each data grouping included in the road network data Rn and in the route pre-calculation data Pr. With this comparative table, the permanent ID data and its associated grouping of substantive data stored in the difference data file Df can be associated with the data grouping stored in the local storage database 15, and each of the data groupings in the local storage database 15 may be updated on the basis of the difference data file Df accordingly. Note that the local storage database 15 is different from the referential database 19. The local storage database 15 is not divided in accordance with application programs but is a single database.

The local storage database update means 14 is a means for updating the contents of the local storage database 15 with the data included in the difference data file Df. As described above, the difference data file Df includes the section ID data da (see FIG. 9). The section ID data df and dj (see FIG. 10 and FIG. 11) are assigned to the road network data Rn and the route pre-calculation data Pr in the local storage database 15. Accordingly, the local storage database update means 14 can update the road network data Rn and the route pre-calculation data Pr in the section with the matching difference data file, i.e., matching section ID data da, df, and dj. The method for the update will vary according to the update mode for updating the target data stored in the difference data file Df, e.g., “addition”, “change”, or “deletion”.

When the update mode is “addition”, the local storage database update means 14 adds the update data for the update to the data within the data category having the corresponding data category ID dd in the difference data file Df, in the road network data Rn or the route precalculation data Pr. Then, information indicating the added data is added to the address data in the header unit dh and dm (see FIG. 10 and FIG. 11). In addition, the local storage database update means 14 updates the comparative table and adds the information of the record code and the permanent ID of the added data. When the update mode is “change”, the local storage database update means 14, on the basis of the comparative table shown in FIG. 12, first obtains the information for the record code of the corresponding data on the basis of the permanent ID of the update data stored in the difference data file Df 7. Then, by reference to the address data in the header unit dh and dm in the road network data Rn and the route pre-calculation data Pr stored in the local storage database 15, the position where the data targeted for update is stored is obtained and the targeted data is rewritten. When the update mode is “deletion”, the local storage database update means 14, on the basis of the comparative table shown in the FIG. 12, first obtains the record code for the corresponding data as identified by the permanent ID of the data targeted for update stored in the difference data file Df 7. Then, by referring to the address data in the header unit dh and dm of the road network data Rn and the route pre-calculation data Pr stored in the local storage database 15, the position where the data targeted for the update is stored is obtained and that targeted data and its address data are deleted from the local storage database 15. In addition, the local storage database update means 14 updates the comparative table and deletes the information of the record code and the permanent ID for the deleted targeted data.

When the local storage database update mans 14 updates the local storage database 15 with the difference data file Df, the local storage database update means 14 updates the version identification dg in the road network data Rn (see FIG. 10) and the version identification Dk in the route pre-calculation data Pr (see FIG. 11) corresponding to the updated section in the local storage database 15, so as to match version identification db in the difference data file Df (see FIG. 9).

The priority determination means 16, after the updating of the local storage database 15, determines the conversion priority for the plurality of groupings of the road network data Rn and the route pre-calculation data Pr divided into sections and stored in the local storage database 15 in accordance with the application programs PG1, PG2, PG3, PG4, and PG5 included in the navigation program PG. Subsequently, in the present embodiment, the priority determination means 16 determines each of the conversion priorities of the various data groupings as one of the three levels “high”, “middle” and “low”.

In the case where a guidance route has been set, the priority determination means 16 makes the conversion priority of the guidance route data higher than that of the other data. More specifically, in the case a guidance route is set, the priority determination means 16 makes the conversion priority “high” for the road network data Rn corresponding to all the sections including the set guidance route in each of the layers 1, 2 and 3. In addition, the priority determination means 16 makes the conversion priority “high” for the route pre-calculation data Pr for a route or routes between the section in layer 2 including the starting point (i.e., the departing area) and the section in layer 2 including the destination (i.e., the destination area). Next, the conversion priority for the road network data Rn corresponding to the section which is adjacent to the section with “high” conversion priority is determined as “middle”. Further, the conversion priority for the route pre-calculation data Pr for routes between the departing area and the sections other than the destination area, and the conversion priority for the route pre-calculation data Pr for routes between the destination area and the sections other than the departing area is set as “middle”. Finally, the conversion priority for the rest of the road network data Rn and the route pre-calculation data Pr is set as “low”.

On the other hand, when a guidance route has not been set, the priority determination means 16 sets the conversion priority for the data required for the peripheral guidance in the vicinity of the current location higher than that for the other data. More specifically, when a guidance route has not been set, the priority determination means 16 makes the conversion priority “high” for the road network data Rn corresponding to the sections in each layer 1, 2, and 3 including the current location. Next, the conversion priority for the road network data Rn corresponding to a section which is adjacent to the section with “high” conversion priority is set as “middle”. Further, the conversion priority for the route pre-calculation data Pr between the section in the layer 2 including the current location and all the other sections is set as “middle”. Finally, the conversion priority for the remainder of the road network data Rn and the route pre-calculation data Pr is set as “low”.

The conversion means 17 converts the data format of the road network data Rn and the route pre-calculation data Pr stored in the local storage database 15 from the update format to the referential data format on the basis of the conversion priority determined by the priority determination means 16. More specifically, the conversion means 17 converts the data format of the road network data Rn and the route pre-calculation data Pr with “high” conversion priority first and, next, converts the data format for that data with “middle” conversion priority and followed by that with “low” conversion priority. Further, within the road network data Rn, the conversion means 17 converts the data arrayed in the order of the data categories in the update data format as shown in FIG. 10 to data arrayed in the order of the connection within the road network in the referential data format as shown in FIG. 6. Further, for the route pre-calculation data Pr, the conversion means 17 converts the update data format, which is independent from the road network data Rn as shown in FIG. 11, to the referential data format which is associated with the road network data Rn.

As described above, the referential database 19 is divided and stored as a plurality of application program databases 19a, 19b, 19c, 19d, and 19e. The data in the present embodiment is arranged so that the conversion means 17 is able to convert a grouping of road network data Rn stored in the local storage database 15 in the update data format into road network data Rn in one of a plurality types of the referential data format suitable for use by, respectively, the application programs PG1, PG2, PG3, PG4, and PG5. Thus, the road network data Rn is divided into the different application databases 19a, 19b, 19c, 19d, and 19e. Therefore, the conversion means 17 can process the road network data Rn from the update data format to the referential data format for one predetermined section, or section-by-section.

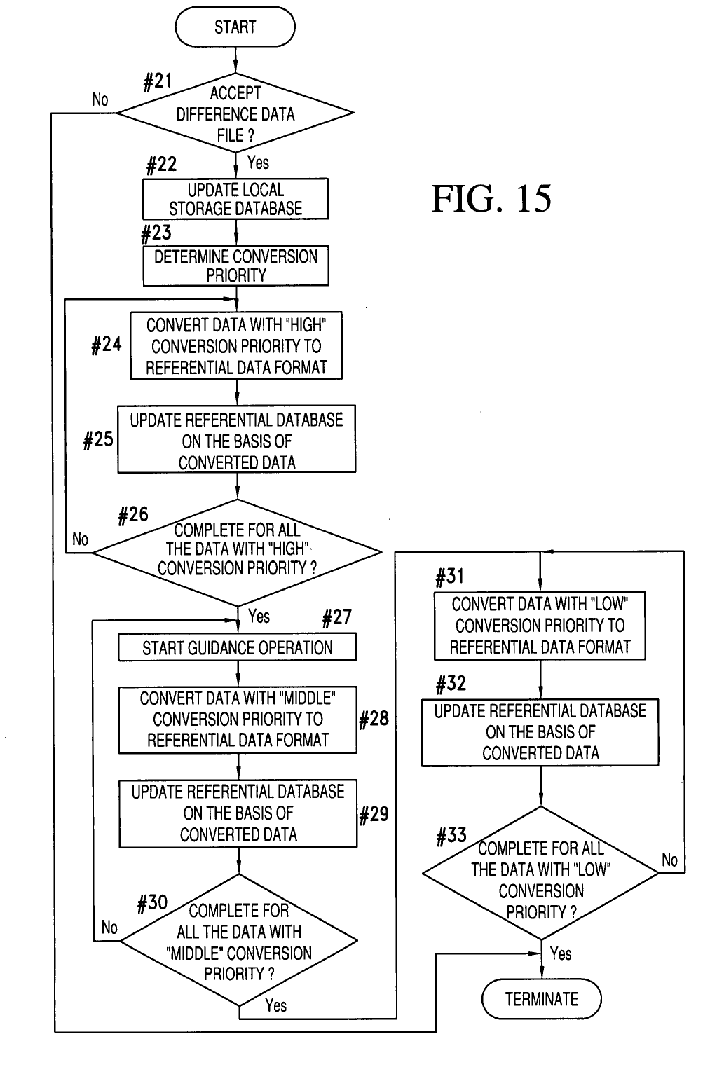

The referential database update means 18 updates the referential database 19 on the basis of the road network data Rn and the route pre-calculation data Pr as converted by the conversion means 17. The referential database update means 18 executes the updating of the referential database 19 in the order of the conversion priority set by the conversion means 17. It takes a relatively long period of time to complete the conversion of all the data in the local storage database 15 and, subsequently, it takes a relatively long period of time to complete the updating of all the data in the referential database 19. Therefore, in the present embodiment, the referential database update means 18, within the referential database 19, first updates that data having a conversion priority higher than the predetermined level, i.e., the data with “high” conversion priority, after conversion by the conversion means 17. Accordingly, in the referential database 19, that data having a high conversion priority may be updated in a relatively short period of time and the newly updated information may be provided to a user quickly. The data with lower conversion priority, i.e. the data with “middle” and “low” conversion priority in the present embodiment, will not be utilized by the navigation program Pg unless the destination is changed or like change, and the referential database update means 18 updates such data in the referential database 19 in parallel with output of the guidance by execution of the navigation program PG. The operation of the referential database update mans 18 as described above will be explained in further detail hereinafter with reference to a flowchart shown in FIG. 15. More specifically, while the conversion means 17 converts the road network data Rn and the route pre-calculation data Pr to referential data formats, corresponding respectively to the application programs PG1, PG2, PG3, PG4, and PG5, the referential database update means 18 updates the referential database 19 on a sectional basis for each conversion.

3. Structure of the Difference Data Generation Server 2.

The difference data generation server 2 is an apparatus for generating the difference data file Df and providing it to the difference data delivery server 3. The difference data generation server 2 comprises an input terminal 31 serving as a new data accepting means, a data category judging means (not illustrated), a comparative local storage database 33, a new local storage database 34, a new local storage database generation means 35, and a difference data file generation means 36.

The input terminal 31 is for accepting the input of the new data. The new data inputted here is that data to be newly added, changed, or deleted for the road network data Rn or the guidance data stored in the referential database 19 in the navigation apparatus 1. For example, when a new road is completed, the intersection data, the connection data, the road data, the shape data, and so forth, included in the road network data Rn for the new road, and various image data, audio data and POI data, i.e., the guidance data required for the newly build road, is inputted at the input terminal 31 as new data. Further, when a road is removed, for example, information is input to identify that part of the road network data Rn that will be unnecessary due to the removal of the road. That information may be the permanent ID or the like for each data grouping. The input terminal 31 may be a personal computer with a keyboard, a mouse, a monitor or the like.

The comparative local storage database 33 has the same content as the local storage database 15 in the navigation apparatus 1. Thus, the comparative local storage database 33 stores the navigation map data such as the road network data Rn and the route pre-calculation data Pr in the update format, by section, as shown in FIG. 10 and FIG. 11, for example. In addition, the comparative local storage database 33, as well as the local storage database 15, stores the comparative table with the record code and the permanent ID for each of the data groupings (items) of the road network data Rn and the route pre-calculation data Pr as shown in FIG. 12. The content of the comparative local storage database 33, by being updated so as to match the content of the new local storage database 34, after generating the difference data file Df, always has the same content as the local storage database 15 in the navigation apparatus 1 which is also updated by the difference data file Df. However, in the present embodiment as described hereinafter, the local storage database 34 stores only that road network data Rn corresponding to the section/sections updated by the new data and the route pre-calculation data Pr as changed by the new data. Thus, when updating the road network data Rn stored in the comparative local storage database 33, only that road network data Rn and the route pre-calculation data Pr stored in the new local storage database 34 is updated. Further, when updating the comparative local storage database 33, the updating is in the order of the version data dg and dk of the updated road network data Rn and the route pre-calculation data Pr (see FIG. 10 and FIG. 11) so as to become the same version as the version db of the generated difference data file Df (see FIG. 9).

The new local storage database 34 has the same data format as that of the comparative local storage database 33 and its data is that is updated with the new data inputted at the input terminal 31. Thus, the new local storage database 34, as well as the comparative local storage database 33, each stores navigation map data such as the road network data Rn and the route pre-calculation data Pr, in the update data format as shown in FIG. 10 and FIG. 1, and the comparative table with the record code and the permanent ID for each of the data groupings of the road network data Rn and the route pre-calculation data Pr as shown in FIG. 12. However, as described hereinafter, the new local storage database generation means 35 updates the road network data Rn and the route pre-calculation data Pr and stores that updated data in the local storage database 34 by section. Thus, the new local storage database 34 stores the road network data Rn and the route pre-calculation data Pr corresponding to the updated section/sections, and does not store data corresponding to the non-updated section/sections. Further, regarding the comparative table, the updated portion containing the new data is different from the content of the comparative local storage database 33.

The new local storage database generation means 35 (means for generating the new local storage database) generates the new local storage database 34 on the basis of the comparative local storage database 33 and the new data input through the input terminal 31. More specifically, the new local storage database generation means 35 converts the data input through the input terminal 31, corresponding to the part of the road network data Rn that should be added, changed, or deleted, into the update data format which is the same as the data format of the comparative local storage database 33. The new local storage database generation means 35 reads the road network data Rn corresponding to the section targeted for the update (target section) from the comparative local storage database 33 and then updates by adding, changing, or deleting its content of road network data Rn with the converted data. Subsequently, the updated road network data Rn for the target section is stored in the new local storage database 34. In addition, the new local storage database generation means 35, on the basis of the updated road network data Rn of each section, recalculates the route pre-calculation data Pr that has possibly changed due to the update of the road network data Rn. Then, the updated route pre-calculation data Pr is stored in the new local storage database 34 by section. Note that the recalculation of the route pre-calculation data Pr is for at least one section in the layer 2 for which the road network data Rn has been updated. The result is updated route pre-calculation data Pr. The new local storage database generation means 35 then also updates the content of the comparative table (see FIG. 7) by adding, changing, or deleting. Then the updated comparative table is stored in the new local storage database 34.

When building of a new road is completed, for example, the intersection data, the connection data, the road data, and the shape data, for that part of the road network data Rn of the new road, is input through the input terminal 31. Then, the new local storage database generation means 35 converts the data format of that newly input data to the update data format, reads the existing road network data Rn corresponding to the section targeted for update from the comparative local storage database 33 on the basis of coordinates, the connection data, and so forth, for each item of data, and adds the data corresponding to the new road to the existing road network data Rn. In this case, the new local storage database generation means 35 also makes necessary changes to any related data within the pre-existing road network data Rn. In addition, the new local storage database generation means 35 recalculates the route pre-calculation data Pr which may have changed due to the update of the road network data Rn as described above. The data format of the updated route pre-calculation data Pr is converted to the update data format and then stored in the new local storage database 34 by section. Further, the new local storage database generation means 35 also assigns a new permanent ID for the newly added data and adds the new permanent ID to the comparative table (see FIG. 7). On the other hand, when a road is removed, information which specifies the part of the road network data Rn that is no longer required due to the removal of the road, is input through the input terminal 31. Then, the new local storage database generation means 35 reads the existing road network data Rn corresponding to the section targeted for the update from the comparative local storage database 33, deletes that portion of the data of the road network data Rn which has become unnecessary from the existing road network data Rn, and makes the necessary changes to the related data at the same time. In addition, the new local storage database generation means 35 recalculates the route pre-calculation data Pr which may have changed due to the update of the road network data Rn as described above. Then the resulting updated route pre-calculation data Pr is converted to the update data format and stored in the new local storage database 34 by section. Further, the new local storage database generation means 35 also deletes the permanent ID for the deleted data from the comparative table (see FIG. 7).

The difference data file generation means 36 (means for generating the difference data file Df) generates the difference data file Df on the basis of the difference between the comparative local storage database 33 and the new local storage database 34. As described above, the comparative local storage database 33 has the same content as the local storage database 15 in the navigation apparatus 1. The new local storage database 34 contains data in the same data format as that in the comparative local storage database 33 and includes the data which was updated in accordance with the input of new data through the input terminal 31. Accordingly, by comparing the content of the foregoing two databases and extracting the difference, the road network data Rn and the route pre-calculation data Pr data for the difference data file Df is obtained. Then, the difference data file generation means 36 arranges the thus obtained data and generates the difference data file Df arranged in a data format predetermined for the difference data file Df. Note that the difference data file Df is generated by section corresponding to the updated section/sections stored in the new local storage database 34.

In the present embodiment, as shown in FIG. 9, the data in the difference data file Df is arranged in the order of the data categories to include the section ID data da and the version data db followed by the update mode such as “addition”, “change”, or “deletion”. The section ID data da indicates the section of the road network data Rn and the route pre-calculation data Pr which is the target for update by the difference data file Df, i.e., one or both sections of the route pre-calculation data Pr which is fundamental to generation of the difference data file Df. The difference data file generation means 36 counts the number of times the difference data file Df has been generated in the past and stores that number in a version data storage means (not illustrated), then assigns a serial number or the like as the version data db, depending on the number of such generations. Note that, in the present embodiment, the number of generations of a difference data file Df is counted by section in accordance with the section/sections of the road network data Rn and the route pre-calculation data Pr, and the serial number of the like for that section becomes the version data db. The permanent ID associated with each item (“group”, “grouping” or “set”) of the substantive data is assigned on the basis of the comparative table stored in the new local storage database 34 (see FIG. 12). The update mode data dc representing the update mode or the data category ID data dd is assigned on the basis of the table (not illustrated) included in the difference data file generation means 36. Subsequently, the difference data file Df generated by the difference data file generation means 36 is transmitted to the difference data delivery server 3and stored in a difference database 41.

4. Structure of the Difference Data Delivery Server 3.

The difference data delivery server 3 is a server apparatus for providing the difference data file Df, generated by the difference data generation server 2, to the navigation apparatus 1. In order to provide this function, the difference data delivery server 3 includes the difference database 41 and a delivery means 42 and a media creation means 43, serving as a difference data file output means 44, for outputting the difference data file Df to the navigation apparatus 1.

The difference database 41 stores the difference data file Df generated by the difference data generation server 2. This difference database 41 stores all the difference data files Df that have been generated in the past. That is to say, the difference database 41 stores one or more versions of difference data file Df for each section.

The delivery means 42 is a means for delivering the difference data file Df to the navigation apparatus 1. In the present embodiment, the delivery means 42 delivers the difference data file Df to the navigation apparatus 1 via the wireless base station 4 or the communication network 6 and the update terminal 5. The media creation means 43 writes the difference data file Df stored in the difference database 41 into the memory media Me on the basis of directions from an operation means in the difference data delivery server 3. The method for providing the difference data file Df by the difference data delivery server 3 will be explained hereinafter in detail with reference to a flowchart.

5. The Method for Generating the Difference Data File.

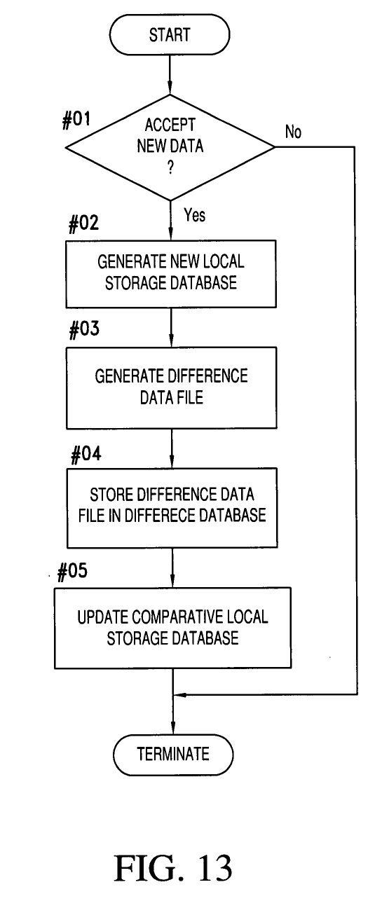

Next, the method for generating the difference data file Df by the difference data generation server 2 will be explained with reference to the flowchart shown in FIG. 13. In the difference data generation server 2, upon accepting the input of new data through the input terminal 31 (step #1: Yes), the new local storage database generation means 35 generates the new local storage database 34 on the basis of the accepted data and the content of the comparative local storage database 33 (step #02). Next, the difference data file generation means 36 generates the difference data file Df on the basis of the difference between the comparative local storage database 33 and the new local storage database 34 (step #3). Then, the generated difference data file Df is transmitted to the difference data delivery server 3 and stored in the difference database 41 (step #4). Thereafter, the content of the comparative local storage database 33 is updated to match the content of the new local storage database 34 (step #5). Upon completion of steps #1 through #5, the process for generating the difference data file Df by the difference data generation server 2 is terminated.

6. The Method for Providing the Difference Data File.

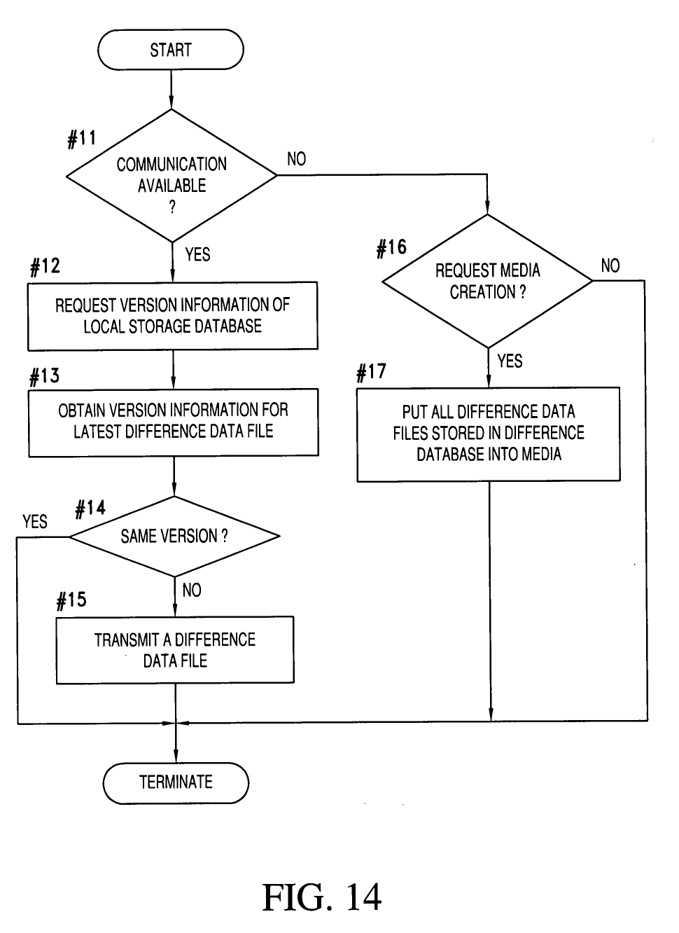

Next, the method for providing the difference data file Df to the navigation apparatus 1 by the difference data delivery server 3 will be explained with reference to the flowchart shown in FIG. 14. In the difference data delivery server 3, the delivery means 42 determines whether any communication is available with the navigation apparatus 1 (stet #11). Note that the delivery means 42, as described above, communicates with the navigation apparatus 1 via the wireless base station 4 or the communication network 6 and the update terminal 5. If any communication is available with the navigation apparatus 1 (step #11: Yes), the delivery means 42 then communications identification of the version of the road network data Rn and the route pre-calculation data Pr stored in the local storage database 15 to the navigation apparatus 1 (step #12). The navigation apparatus then reads each version ID dg and dk for the road network data Rn and the route precalculation data Pr stored by section in the local storage database 15 (see FIG. 10 and FIG. 11), and then transmits it to the difference data delivery server 3 to identify the version of the road network data Rn and the route pre-calculation data Pr for each section.

Meanwhile, the delivery means 42 obtains the latest version of the difference data file Df for each of the sections on the basis of the version data db of each of the difference data files Df stored in the difference database 41 (step #13). Then, the delivery means 42 compares the information of the latest version of the difference data file Df for each section obtained (through step #13) with the information, identifying the version of the road network data Rn and the route pre-calculation data Pr for each section received from the navigation apparatus 1, and then determines whether or not the versions are the same (step #14). In this case, the version comparison is made with the difference data file Df and the road network data Rn and the route pre-calculation data Pr with the same section ID data da, df, and dj (see FIG. 9, FIG. 10, and FIG. 11), by section. If the versions are not the same (step #14: NO), that is to say, the latest version of the difference data file Df for a given section is newer than the version of the road network data Rn and the route pre-calculation data Pr for that section in the navigation apparatus 1, the difference data file Df which is the newer version of the road network data Rn and the route pre-calculation data is transmitted to the navigation apparatus 1. On the other hand, if the versions are the same (step #14. Yes), that is to say, the latest version of the difference data file Df for the section is the same as that version of the road network data Rn and the route pre-calculation data Pr already stored in the navigation apparatus 1, there is no need to update with the difference data file Df, and the processing is terminated without transmitting the difference data file Df.

On the other hand, when no communication is available between the delivery means 42 operation means within the navigation apparatus 1 (step #11: No), the difference data delivery sever 3 determines whether or not media creation is required (step #16.). If media creation is required, the entire difference data file Df stored in the difference database is written into the memory media Me (step #17). The memory media Me created as above, storing the difference data file Df, may be sent to a user or a service provider using the navigation apparatus 1, by postal service or otherwise. Execution of the foregoing routine is then terminated.

7. The Method for Updating the Referential Database 19 in the Navigation Apparatus 1.

Next, the method for updating the referential database 19 in the navigation apparatus 1 will be explained with reference to the flowchart shown in FIG. 15. When the difference data file accepting means 13 accepts the difference data file Df (step #21: Yes), the navigation apparatus I transmits the accepted difference data file Dr to the local storage database update means 14 and the local storage database update means 14 then uses the data in file Df to update the data such as the road network data Rn and the route pre-calculation data Pr stored in the local storage database 15 (step #22).

Next, in the navigation apparatus 1, the priority determination means 16 determines the conversion priority for the groupings of the road network data Rn and the route pre-calculation data Pr that are sorted by section and stored in the local storage database 15, after updating in step #22, according to the operation state of the navigation program PG (step #23). In the present embodiment, as described above, the priority determination means 16 determines the conversion priority as one of three levels “high”, “middle”, or “low”, according to the operational state of each of the application programs PG1, PG2, PG3, PG4, and PG5. Next, the conversion means 18 converts the data having conversion priority higher than the predetermined level, i.e., the road network data Rn and the route pre-calculation data Pr with “high” conversion priority, to the referential data format (step #24). Thereafter, the referential database 19 is updated on the basis of the data converted in step #24 (step #25). Then, the conversion (step #24) and the updating of the referential database 19 (step #25) are repeated until conversion of all the data with “high” conversion priority and updating are completed (step #26: No). After completing the conversion (step #24) and the updating of the referential database 19 (step #25) for all the data with “high” conversion priority (step #26: Yes), the navigation computing means 20 starts guidance by execution of the navigation program PG (step #27). Note that the guidance operation described above includes all the guidance operations of the navigation apparatus such as display of current location, calculation of a route from a departing point to a destination, guidance to the destination, destination searching, and so forth.

More specifically, when a guidance route is set by execution of the navigation program PG, after completing the conversion of the data having “high” conversion priority (step #24) and the updating of the referential database 19 (step #25) (step #26: Yes), the route calculation is executed once again and guidance to the destination and/or display of the current location is provided in accordance with the newly updated data (step #27). On the other hand, when a guidance route has not been set, after completion of the conversion of the “high” conversion priority data (step #24) and the updating of the referential database 19 (step #25) (step #26: Yes), the current location and map of the vicinity around the current location are displayed (step #27). After the start of guidance in either case, a destination search, new destination setting, or other operation will be available.

Thereafter, in parallel with (simultaneously with) the foregoing guidance operation, the conversion means 17 converts the “middle” priority road network data Rn and route pre-calculation data Pr to the referential data format (step #28). Then, the referential database 19 is updated with the data converted in step #28 (step #29). The conversion process (step #28) and the updating of the referential database 19 (step #29) are repeated until completion for all the “middle” priority data (step #30: No). Thereafter, after completion of conversion of all the “middle” priority data (step #28) and the updating of the referential database 19 (step #29) (step #30: Yes), the conversion means 17 converts the “low” conversion priority road network data Rn and route re-calculation data Pr to the referential data format (step #31). Thereafter, the referential database 19 is updated with the data converted in step #31 (step #32). The conversion processing (step #31) and the updating of the referential database 19 (step #32) are repeated until completed for all data having a “low” conversion priority (step #33: No). In the foregoing manner, the entire referential database 19 is eventually updated and the operation is then terminated.

### Modifications

(1) While the structures (formats) of the road network data Rn and the difference data file Df are described above as the referential data format, the update data format, and so forth, such are merely exemplifications, and other formats may be adopted to provide data structures different from the data structures in the embodiment described below.

(2) In the embodiment described above, the local storage database 15 is updated with the difference data file Df and then the referential database 19 is updated in accordance with updated local storage database 15 for both the road network data Rn and the route pre-calculation data Pr. However, for example, the local storage database 15 is updated with the difference data file Df only for either the road network data Rn or the route pre-calculation data Pr, and then the referential database 19 is updated on the basis of the updated local storage database 15.

(3) In the embodiment described above, the priority determination means 16 determines the conversion priority as one of the three levels “high”, “middle”, or “low”. However, the priority determination means 16 may determine the conversion priority as one of four or more levels, or as one of two levels. In addition, each of the plurality of data groupings stored in the local storage database 15 may have a different conversion priority.

(4) In the embodiment described above, road network data Rn and the route pre-calculation data Pr are divided into a plurality of sections, and the priority determination means 16 determines the conversion priority for each section as the smallest unit. However, for example, the priority determination means 16 may determine conversion priority for the road network data Rn and the route pre-calculation data Pr divided into predetermined areas and subdivided into a plurality of sections as the smallest unit, or the conversion priorities may be determined for regions smaller than a section.

(5) In the embodiment described above, when a guidance route is set, the conversion means 17 sets the conversion priority for data pertaining to the set guidance route higher than that set for the other data. Further, when a guidance route has not been set, the conversion means 17 sets the conversion priority for the data required for peripheral guidance in the vicinity of the current location higher than that set for the other data. However, the foregoing criteria for setting conversion priority are merely examples, and the determination may be based on other criteria. Note that, even applying some other criteria, it is still preferred to set the conversion priority higher for that data which has the greatest possibility for use, such as the data for guidance, in order to make the newly updated information more promptly available to a user.

(6) In the embodiment described above, the referential database update means 18 updates the referential database 19 with the data as converted in the conversion order of conversion by the conversion means 17. However, the order for updating the data is not so limited and the referential database 19 may be updated in an order different from that of the conversion priority. For example, the data converted in the order of the conversion priority may be temporally stored in memory and, after all the data is converted, the referential database 19 may be updated. In this modification, it is preferred that the thus stored converted data be utilized in execution of the navigation program PG.

(7) In the embodiment described above, the content of the comparative local storage database 33 in the difference data generation server 2 is updated to match the content of the new local storage database 34. The newly generated difference data file Df. In this case, the content of the comparative local storage database 33 before the update may be deleted. However, it may be preferred to retain the prior version and to store in the comparative local storage database 33 a plurality of versions of the road network data Rn and the route pre-calculation data Pr for each section.

(8) In the described embodiment, the difference data generation server 2 generates the new local storage database 34 on the basis of the new data and then generates the difference data file Df on the basis of the difference between the contents of the comparative local storage database 33 and the new local storage database 34. However, operation of the difference data generation server 2 is not so limited. For example, the difference data generation server 2 may generate the difference data file Df on the basis of the new data and the comparative local storage database 33 without generating the new local storage database 34.

(9) In the embodiment described above, the difference data file Df is generated on the basis of at least the new data and the comparative local storage database 33 by means of the difference data generation server 2. However, the server apparatus of the present invention is not so limited. For example, the input terminal 31 may receive input of the data equivalent to the difference data fie Df directly and store it in the difference database 41. In such a case, the server apparatus may comprise only a difference data accepting means, in addition to an equivalent to the difference data delivery server 3 described above.

(10) In the embodiment described above, the server apparatus includes both the difference data generation server 2 and the difference data delivery server 3. However, in the alternative, the function of the difference data generation server 2 and the function of the difference data delivery server 3 may be combined into a single server apparatus.

(11) In the embodiment described above, the navigation program PG includes a plurality of application programs PG1, PG2, PG3, PG4, and PG5 utilizing, respectively, the application program databases 19a, 19b, 19c, 19d, and 19e of differing formats. However, in the alternative, the referential database 19 may store the data in a single referential data format. In other words, the data stored in the referential database 19 need not be sorted into a plurality of difference databases. Further, the operation program need not be a plurality of application programs.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A data update system comprising:
a navigation apparatus operated in accordance with an operation program; and
a server apparatus for providing a difference data file for updating a database to the navigation apparatus;
wherein the navigation apparatus comprises:
a local storage database in an update data format that is different from a referential data format utilized by the operation program, the local storage database being updated by the difference data file;
priority determination means for, after updating the local storage database, determining a conversion priority for a plurality of data groupings stored in the local storage database, in accordance with an operation state of the operation program; and
conversion means for converting data stored in the local storage database to the referential data format in the order of the conversion priority; and
wherein the server apparatus includes a difference data file output means for outputting the difference data file to be provided to the navigation apparatus.

2. The data update system according to claim 1, wherein, when a guidance route has been set by the operation program, the priority determination means makes the conversion priority for data for the guidance route higher than other data.

3. The data update system according to claim 1, wherein, when a guidance route has not been set, the priority determination means makes the conversion priority for data required for peripheral guidance for vicinity of a current location higher than other data.

4. The data update system according to claim 1, wherein the navigation apparatus includes a referential database that stores data in a referential data format to be utilized by the operation program and a referential database update means for updating the referential database on the basis of the converted data.

5. The data update system according to claim 4, wherein the referential database update means updates the referential database preferentially for data having a conversion priority higher than a predetermined level after being converted by the conversion means, and updates data within the referential database having a conversion priority lower than the predetermined level in parallel with generation of guidance by execution of the operation program.

6. The data update system according to claim 1, wherein data stored in the local storage database includes road network data wherein the referential data format is a data format in which road network is arrayed in the order of connection with a road network, and wherein the update data format is a data format in which groupings of the road network data are arrayed in the order of data categories.

7. The data update system according to claim 1, wherein data stored in the local storage database includes route pre-calculation data, obtained by pre-calculation of plural routes between a departing area and a destination area and road network data, and wherein the difference data file includes data representing an update mode, road network data corresponding to data targeted for update, and the route pre-calculation data corresponding to targeted data.

8. The data update system according to claim 7, wherein, when a guidance route has been set by execution of the operation program, the priority determination means makes the conversion priority of the route pre-calculation data connecting the departing area and the destination area of the guidance route higher than that for the other data.

9. The data update system according to claim 1, wherein the server apparatus includes a comparative local storage database having the same content as the local storage database, a new data accepting means for accepting input of new data, and a difference data file generation means for generating the difference data file on the basis of the comparative local storage database and the new data.

10. The data update system according to claim 9, wherein the server apparatus further includes a new local storage database generation means for generating a new local storage database having the same data format as the comparative local storage database and being updated with the content of the new data on the basis of the comparative local storage database and the new data, and wherein the difference data file generation means generates the difference data file on the basis of the difference between the comparative local storage database and the new local storage database.

11. A navigation apparatus operated in accordance with a predetermined operation program while accepting a difference data file for updating a database from a server apparatus, comprising:
a local storage database containing data in an update data format that is different from a referential data format used in execution of the operation program, the local storage database being updated by the difference data file;
priority determination means for, after updating the local storage database, determining a conversion priority for a plurality of data groupings stored in the local storage database in accordance with state of operation of the operation program; and
conversion means for converting data stored in the local storage database to the referential data format in the order of the conversion priority.

12. The navigation apparatus according to claim 11, wherein, when a guidance route has been set by execution of the operation program, the priority determination means makes the conversion priority for data pertaining to the guidance route higher than that for the other data.

13. The navigation apparatus according to claim 11, wherein, when a guidance has not been set, the priority determination means makes the conversion priority for data required for peripheral guidance in vicinity of a current location higher than that for the other data.

14. The navigation apparatus according to claim 11 further comprising a referential database containing data in a referential data format which can be used in execution of the operation program and a referential database update means for updating the referential database data as converted by the conversion means.

15. The navigation apparatus according to claim 14, wherein the referential database update means preferentially updates data in the referential database having a conversion priority higher than a predetermined level after conversion, and updates data in the referential database having a conversion priority lower than the predetermined level in parallel with a guidance operation generated by execution of the operation program.

16. The data update system according to claim 11, wherein data stored in the local storage database includes road network data wherein the referential data format is a data format in which groupings of road network data are arrayed in the order of connection within a road network, and wherein the update data format is a data format in which groupings of the road network data are arrayed in the order of data categories.

17. The data update system according to claim 11, wherein data stored in the local storage database includes route pre-calculation data, obtained by pre-calculation of plural routes between a departing area and a destination area and road network data, and wherein the difference data file includes data representing an update mode, road network data corresponding to data targeted for update, and the route pre-calculation data corresponding to targeted data.

18. The data update system according to claim 17, wherein, when a guidance route has been set by execution of the operation program, the priority determination means makes the conversion priority of the route pre-calculation data connecting the departing area and the destination area of the guidance route higher than that for the other data.

19. A data update method for updating a database by providing a difference data file from a server apparatus to a navigation apparatus, the navigation apparatus having a local storage database containing data in an update data format that is different from a referential data format utilized in execution of an operation program, wherein the method comprises:
outputting the difference data file from the server apparatus to the navigation apparatus; and
at the navigation apparatus:
accepting the difference data file;
updating the local storage database with the difference data file;
determining, after updating the local storage database, a conversion priority for a plurality of data groupings stored in the local storage database according to state of operation state of the operation program;
converting data stored in the local storage database to the referential data format in the order of the conversion priority, thus making the converted data available for use in execution of the operation program.

20. The data update method according to claim 19, wherein, when a guidance route has been set, the data for the guidance route is given a conversion priority higher than that for the other data.

21. The data update method according to claim 19, wherein, when a guidance route has not been set, making the conversion priority for data required for peripheral guidance in a vicinity of a current location higher than that for the other data.

22. The data update method according to claim 19, wherein the navigation apparatus further has a referential database for storing the data converted to the referential format, and wherein data in the referential database having a conversion priority higher than a predetermined level is updated first and then data in the referential database having a conversion priority lower than the predetermined level is updated in parallel with a guidance operation by execution of the operation program.

23. The data update method according to claim 19, wherein data stored in the local storage database includes route pre-calculation data, obtained by pre-calculation of plural routes between a departing area and a destination area, and road network data, and wherein, when a guidance route has been set by execution of the operation program, the pre-calculation data for routes connecting the departing area and the destination area of the guidance route is given a higher priority than that of the other data.

24. The data update method according to claim 19, wherein the server apparatus includes a comparative local storage database having the same content as the local storage database and wherein the method further comprises:
accepting input of new data at the server; and
generating the difference data file on the basis of the comparative local storage database and the new data.

25. The data update method according to claim 24, wherein the server apparatus generates a new local storage database having the same data format as the comparative local storage database and being updated with the content of the new data on the basis of the comparative local storage database and the new data, and generates the difference data file on the basis of the difference between the comparative local storage database and the new local storage database.
